(19) United States
(12) Patent Application Publication
(10) Pub. No.: US 2005/0094174 A1
(43) Pub. Date: May 5, 2005

(54) All-in-one printing system having an operator panel

(76) Inventors: Stephen K. Cunnagin, Lexington, KY (US); David K. Murray, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/689,323

(22) Filed: Oct. 20, 2003

(51) Int. Cl. G06F 3/12; G06F 9/00

(52) U.S. Cl. 358/1.13; 715/700

(57) ABSTRACT

In one illustration, the all-in-one printing system includes a machine adapted to function as at least two different devices chosen from a printer, copier, scanner, facsimile, and photo card reader. A first operator panel, when attached, interfaces with the machine controller electronics to selectively activate the machine controller electronics to enable the machine to function as at least one of the devices. A second operator panel, when attached instead of the first operator panel, interfaces with the machine controller electronics to selectively activate the machine controller electronics to enable the machine to function as at least a different one of the devices. In another illustration, the machine controller electronics, when activated by the first or second operator panel, enables the machine to function as at least one device in a computer-host-based mode. The second operator panel has operator-panel controller electronics for the machine to also operate in a stand-alone-based mode.

### TECHNICAL FIELD

The present invention relates generally to printing, and more particularly to an all-in-one printing system having an operator panel.

### BACKGROUND OF THE INVENTION

Conventional all-in-one printing systems include those which provide several functions in a single package such as printing, copying, scanning, faxing, and photo card reading. In one known system, a first operator panel is attached to a machine, wherein the machine, to reduce cost, contains minimal machine controller electronics to enable the machine to operate, for example, only as a printer with the attached first control panel. New upgraded machine controller electronics can replace the minimal machine controller electronics and a second control panel can replace (or be added to) the first control panel to enable the machine to also operate, for example, as a scanner. In another known system, a coping machine uses a first operator panel and a second operator panel is an add-on operator panel to the first operator panel and contains added controller electronics to enable the copying machine to also operate as a facsimile machine.

What is needed is an improved all-in-one printing system having an operator panel.

### SUMMARY OF THE INVENTION

One expression of an embodiment of the invention is for an all-in-one printing system which includes a machine which is adapted to function as at least two different devices. The at least two different devices are chosen from the group consisting of a printer, a copier, a scanner, a facsimile device, and a photo card reader. The machine includes machine controller electronics which alone, when activated, enables the machine to function as all of the at least two different devices. The machine is adapted to receive a first operator panel and to receive a second operator panel instead of the first operator panel. The first operator panel is removably attachable to the machine and when attached to the machine interfaces with the machine controller electronics to selectively activate the machine controller electronics to enable the machine to function as at least one of the at least two different devices. The second operator panel is removably attachable to the machine instead of the first operator panel and when attached to the machine interfaces with the machine controller electronics to selectively activate the machine controller electronics to enable the machine to function as at least a different one of the at least two different devices.

Another expression of an embodiment of the invention is for an all-in-one printing system including a machine which is adapted to function as at least one device. The at least one device is chosen from the group consisting of a printer, a copier, a scanner, a facsimile device, and a photo card reader. The machine includes machine controller electronics which alone, when activated, enables the machine to operate in a computer-host-based mode. The machine is adapted to receive a first operator panel and to receive a second operator panel instead of the first operator panel. The first operator panel is removably attachable to the machine and when attached to the machine interfaces with the machine controller electronics to activate the machine controller electronics to enable the machine to operate in the computer-host-based mode. The machine cannot operate in a stand-alone-based mode when the first operator panel is attached to the machine. The second operator panel is removably attachable to the machine instead of the first operator panel and has operator-panel controller electronics for the machine to operate in the stand-alone-based mode. The second operator panel, when attached to the machine interfaces with the machine controller electronics to operate the machine in the stand-alone-based mode and to activate the machine controller electronics to enable the machine to also function in the computer-host-based mode.

Several benefits and advantages are derived from one or more of the expressions of an embodiment of the invention. Having machine controller electronics which enable all machine functions and having different operator panels selectively activate the machine controller electronics to differentiate machine functionality allows for late-stage differentiation of a base machine, which helps to maintain a low inventory of a base product. If there is a demand shift between products, this can be compensated for easily by simply differentiating base products based on changing demands. Simple insertion of a different operator panel transforms the base product into a different end product to the customer. This differentiation can even occur at a customer point of purchase such as in a retail store. Also, having machine controller electronics which enable all machine functions and having different operator panels selectively activate the machine controller electronics to differentiate machine functionality avoids having to keep track of, and match up, conventional replaceable machine controller electronics and operator panels and avoids having to provide room on the machine for conventional add-on operator panels containing added machine controller electronics. Having a second operator panel with operator-panel controller electronics for the machine to operate in a stand-alone-based mode allows adding a stand-alone-based mode by simply replacing an operator panel.

### BRIEF DESCRIPTION OF THE DRAWINGS

FIG. 1 is a schematic diagram of an embodiment: of a machine adapted to function as a printer, a copier, a scanner, a facsimile device, and a photo card reader; of a first operator panel; and of a computer, wherein the machine is connected to the computer and wherein the first operator panel is removably attached to the machine;

FIG. 2 is a schematic perspective view of the first operator panel of FIG. 1; and

FIG. 3 is a schematic perspective view of an embodiment of a second operator panel which can be used in place of the first operator panel of FIG. 1.

### DETAILED DESCRIPTION

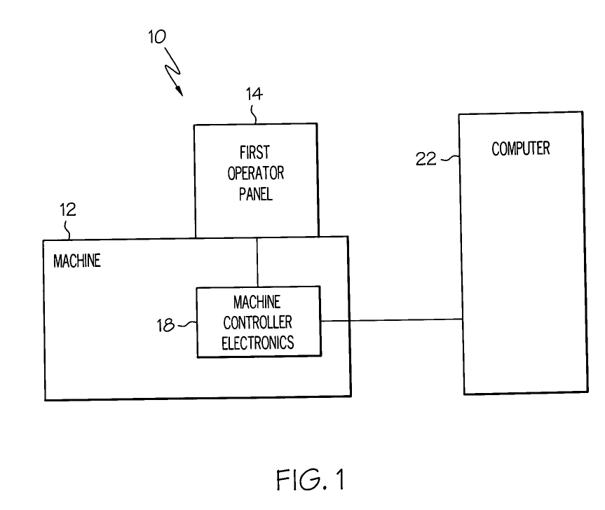

Referring to FIGS. 1-3, a first expression of an embodiment of the invention is for an all-in-one printing system 10 including a machine 12, a first operator panel 14, and a second operator panel 16. The machine 12 is adapted to function as at least two different devices. The at least two different devices are chosen from the group consisting of a printer, a copier, a scanner, a facsimile device, and a photo card reader. The machine 12 includes machine controller electronics 18 which alone, when activated, enables the machine 12 to function as all of the at least two different devices. The first operator panel 14 is removably attachable to the machine 12 and when attached to the machine 12 interfaces with the machine controller electronics 18 to selectively activate the machine controller electronics 18 to enable the machine 12 to function as at least one of the at least two different devices. The second operator panel 16 is removably attachable to the machine 12 instead of the first operator panel 14 and when attached to the machine 12 interfaces with the machine controller electronics 18 to selectively activate the machine controller electronics 18 to enable the machine 12 to function as at least a different one of the at least two different devices.

By “different devices” is meant different items in the listed group such as a printer and a scanner. It is noted that two printers, for example, are not two different devices. By “selectively activate the machine controller electronics” is meant that the first and second operator panels 14 and 16 each serve only as a user interface with the machine controller electronics 18 for the machine 12 to function as at least one, or as at least a different one, of the at least two different devices in at least one of a computer-host-based mode (i.e., requiring attachment to a computer host for functioning) and a stand-alone-based mode (i.e., requiring no attachment to a computer host or the like for functioning). By having the machine controller electronics 18 “alone enable the machine to function as all of the at least two different devices” is meant that the machine controller electronics 18 alone provides the functionality for the machine to function as all of the at least two different devices in at least one of a computer-host-based mode and a stand-alone-based mode and that the first and second operator panels 14 and 16 each do not contain any controller electronics which enable (in whole or in part) the machine 12 to function as any of the at least two different devices in at least one of a computer-host-based mode and a stand-alone-based mode.

In one example, the machine 12 is adapted to function as a printer and a photo-card reader, the machine controller electronics 18 alone provides the functionality for the machine 12 to function as a printer and a photo-card reader in a computer-host-based mode. In this example, the first operator panel 14 (which lacks a photo-card-reader slot) provides a user interface with the machine controller electronics 18 for the machine to function as a printer, and the second operator panel 16 (which has a plurality of photo-card-reader slots 20), when used instead of the first operator panel 14 (in the same or a different operator-panel receptacle on the machine 12 as that used for the first operator panel 14) provides a user interface with the machine controller electronics 18 for the machine to function as a printer and as a photo card reader. In an extension of the first example, the machine controller electronics 18 alone provides the functionality for the machine 12 to also function as a scanner in a computer-host-based mode when activated by the first operator panel 14 and when activated by the second operator panel 16. Other examples are left to the artisan.

In one implementation of the first expression of the embodiment of FIGS. 1-3, the machine controller electronics 18, when activated by the first or second operator panel 14 or 16, enables the machine 12 to operate in a computer-host-based mode. A computer 22 is shown attached to the machine 12 in FIG. 1. Examples of computers 22 include, without limitation, printer servers and desktop computers, wherein a desktop computer can be directly attached to the machine 12 or can be indirectly attached to the machine 12 through a printer server. In another implementation, the machine controller electronics, when activated by the first or second operator panel, enables the machine to operate in a stand-alone-based mode. In a further implementation, the machine controller electronics, when activated by the first or second operator panel, enables the machine to selectively operate in a computer-host-based mode and in a stand-alone-based mode. In an additional implementation, the machine controller electronics 18, when activated by the first or second operator panel 14 and 16, enables the machine 12 to operate in a computer-host-based mode, and the second operator panel 16 includes operator-panel controller electronics 24 which together with the machine controller electronics 18 enables the machine to also selectively operate in a stand-alone-based mode. In one variation, the operator-panel controller electronics 24 includes a rasterizing and print formatting application-specific-integrated-circuit (ASIC) 26 and includes a memory 28 operatively connected to the ASIC 26.

In one enablement of the first expression of the embodiment of FIGS. 1-3, the first operator panel 14 includes a first set of at least one push button 30 operatively connected to the machine controller electronics 18 to at least in part selectively activate the machine controller electronics 18 to enable the machine 12 to function as at least one of the at least two different devices when the first operator panel 14 is attached to the machine 12. In this enablement, the second operator panel 16 includes a second set of at least one push button 32 operatively connected to the machine controller electronics 18 to at least in part selectively activate the machine controller electronics 18 to enable the machine 12 to function as at least a different one of the at least two different devices when the second operator panel 16 is attached to the machine 12 instead of the first operator panel 14. In one variation, a pin-socket attachment is used to removably attach an operator panel to the machine, and in one modification jumper pins (not shown) of an operator panel in part selectively activate the machine controller electronics. Other arrangements are left to the artisan.

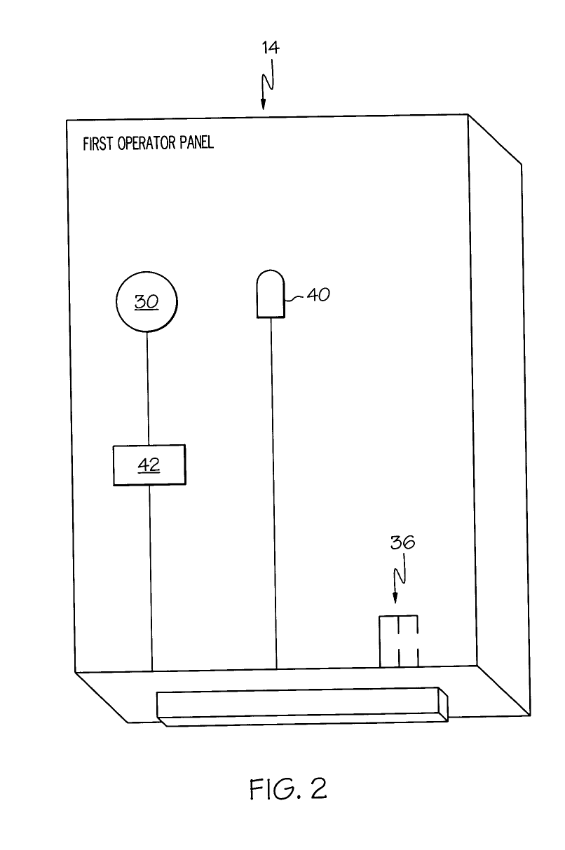

In one application of the first expression of the embodiment of FIGS. 1-3, the first operator panel includes a first display screen (omitted from FIG. 2), the second operator panel 16 includes a second display screen 34, and the machine controller electronics 18 is adapted to display at least one message on the second display screen 34 but not on the first display screen. In a different application, the first operator panel 14 lacks a display screen and the second operator panel 16 includes a display screen 34. In one variation, the display screens are LCD (liquid crystal display) screens.

In one employment of the first expression of the embodiment of FIGS. 1-3, the first operator panel 14 includes a first identification code 36 which is recognizable by the machine controller electronics 18. In this employment, the second operator panel 16 includes a second identification code 38 which is recognizable by the machine controller electronics 18 and which is different than the first identification code 36.

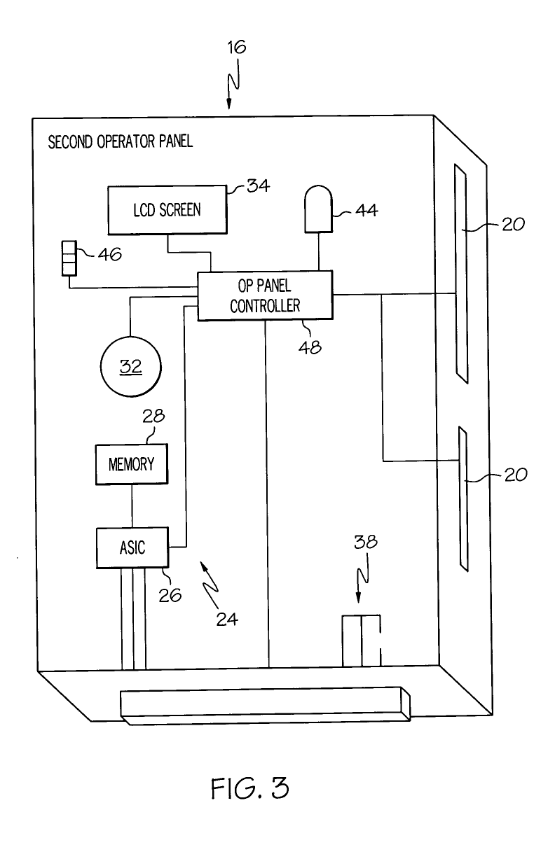

In one illustration of the first expression of the embodiment of FIGS. 1-3, the first set of push buttons 30 (only one button is shown for clarity in FIG. 2) of the first operator panel 14 includes a power button, a paper feed button, a scan button, a black copy button, and a color copy button. In this illustration, the second set of push buttons 32 (only one button is shown for clarity in FIG. 3) of the second operator panel 16 includes a power button, a copy button, a scan button, and an OK button. In one variation, the first operator panel 14 includes a first LED (light-emitting diode) 40 and multiplex lines and serialize data 42 as shown in FIG. 2. In the same variation, the second operator panel 16 includes a second LED 44, a jog button 46, and the operator-panel controller electronics 24 includes an operator-panel controller 48 as shown in FIG. 3. Other illustrations and variations are left to the artisan.

A second expression of the embodiment of FIGS. 1-3 is for an all-in-one printing system 10 including a machine 12 which is adapted to function as at least two different devices. The at least two different devices are chosen from the group consisting of a printer, a copier, a scanner, a facsimile device, and a photo card reader. The machine 12 includes machine controller electronics 18 which alone, when activated, enables the machine 12 to function as all of the at least two different devices. The machine 12 is adapted to receive a first operator panel 14 and to receive a second operator panel 16 instead of the first operator panel 14. The first operator panel 14 is removably attachable to the machine 12 and when attached to the machine 12 interfaces with the machine controller electronics 18 to selectively activate the machine controller electronics 18 to enable the machine 12 to function as at least one of the at least two different devices. The second operator panel 16 is removably attachable to the machine 12 instead of the first operator panel 14 and when attached to the machine 12 interfaces with the machine controller electronics 18 to selectively activate the machine controller electronics 18 to enable the machine 12 to function as at least a different one of the at least two different devices.

A third expression of the embodiment of FIGS. 1-3 is for an all-in-one printing system 10 including a machine 12, a first operator panel 14, and a second operator panel 16. The machine 12 is adapted to function as at least one device. The at least one device is chosen from the group consisting of a printer, a copier, a scanner, a facsimile device, and a photo card reader. The machine 12 includes machine controller electronics 18 which alone, when activated, enables the machine to operate in a computer-host-based mode. The first operator panel 14 is removably attachable to the machine 12 and when attached to the machine 12 interfaces with the machine controller electronics 18 to activate the machine controller electronics 18 to enable the machine 12 to operate in the computer-host-based mode. The machine 12 cannot operate in a stand-alone-based mode when the first operator panel 14 is attached to the machine. The second operator panel 16 is removably attachable to the machine 12 instead of the first operator panel 14, has operator-panel controller electronics 24 for the machine 12 to operate in the stand-alone-based mode, and when attached to the machine 12 interfaces with the machine controller electronics 18 to operate the machine 12 in the stand-alone-based mode and to activate the machine controller electronics 18 to enable the machine 12 to also function in the computer-host-based mode.

In one variation of the third expression of the embodiment of FIGS. 1-3, the operator-panel controller electronics 24 includes a rasterizing and print formatting application-specific-integrated-circuit (ASIC) 26 and includes a memory 28 operatively connected to the ASIC 26. In one employment of the third expression of the embodiment of FIGS. 1-3, the first operator panel 14 includes a first identification code 36 which is recognizable by the machine controller electronics 18. In this employment, the second operator panel 16 includes a second identification code 38 which is recognizable by the machine controller electronics 18 and which is different than the first identification code 36.

A fourth expression of the embodiment of FIGS. 1-3 is for an all-in-one printing system 10 including a machine 12 which is adapted to function as at least one device. The at least one device is chosen from the group consisting of a printer, a copier, a scanner, a facsimile device, and a photo card reader. The machine 12 includes machine controller electronics 18 which alone, when activated, enables the machine 12 to operate in a computer-host-based mode. The machine is adapted to receive a first operator panel 14 and to receive a second operator panel 16 instead of the first operator panel 14. The first operator panel 14 is removably attachable to the machine 12 and when attached to the machine 12 interfaces with the machine controller electronics 18 to activate the machine controller electronics 18 to enable the machine 12 to operate in the computer-host-based mode. The machine 12 cannot operate in a stand-alone-based mode when the first operator panel 14 is attached to the machine 12. The second operator panel 16 is removably attachable to the machine 12 instead of the first operator panel 14, has operator-panel controller electronics 24 for the machine 12 to operate in the stand-alone-based mode, and when attached to the machine 12 interfaces with the machine controller electronics 18 to operate the machine 12 in the stand-alone-based mode and to activate the machine controller electronics 18 to enable the machine 12 to also function in the computer-host-based mode.

It is noted that any of the implementations, enablements, etc. of any expression of the embodiment of FIGS. 1-3 can be used in any other expression of the embodiment of FIGS. 1-3, as can be appreciated by the artisan. In one variation of any expression of the embodiment of FIGS. 1-3, the all-in-one printing system 10 is an all-in-one inkjet printing system.

Several benefits and advantages are derived from one or more of the expressions of an embodiment of the invention. Having machine controller electronics which enable all machine functions and having different operator panels selectively activate the machine controller electronics to differentiate machine functionality allows for late-stage differentiation of a base machine, which helps to maintain a low inventory of a base product. If there is a demand shift between products, this can be compensated for easily by simply differentiating base products based on changing demands. Simple insertion of a different operator panel transforms the base product into a different end product to the customer. This differentiation can even occur at a customer point of purchase such as in a retail store. Also, having machine controller electronics which enable all machine functions and having different operator panels selectively activate the machine controller electronics to differentiate machine functionality avoids having to keep track of, and match up, conventional replaceable machine controller electronics and operator panels and avoids having to provide room on the machine for conventional add-on operator panels containing added machine controller electronics. Having a second operator panel with operator-panel controller electronics for the machine to operate in a stand-alone-based mode allows adding a stand-alone-based mode by simply replacing an operator panel.

The foregoing description of several expressions of an embodiment of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

1. An all-in-one printing system comprising:
a) a machine which is adapted to function as at least two different devices, wherein the at least two different devices are chosen from the group consisting of a printer, a copier, a scanner, a facsimile device, and a photo card reader, and wherein the machine includes machine controller electronics which alone, when activated, enables the machine to function as all of the at least two different devices;
b) a first operator panel which is removably attachable to the machine and which when attached to the machine interfaces with the machine controller electronics to selectively activate the machine controller electronics to enable the machine to function as at least one of the at least two different devices; and
c) a second operator panel which is removably attachable to the machine instead of the first operator panel and which when attached to the machine interfaces with the machine controller electronics to selectively activate the machine controller electronics to enable the machine to function as at least a different one of the at least two different devices.

2. The system of claim 1, wherein the machine controller electronics, when activated by the first or second operator panel, enables the machine to operate in a computer-host-based mode.

3. The system of claim 1, wherein the machine controller electronics, when activated by the first or second operator panel, enables the machine to operate in a stand-alone-based mode.

4. The system of claim 1, wherein the machine controller electronics, when activated by the first or second operator panel, enables the machine to selectively operate in a computer-host-based mode and in a stand-alone-based mode.

5. The system of claim 1, wherein the machine controller electronics, when activated by the first or second operator panel, enables the machine to operate in a computer-host-based mode, and wherein the second operator panel includes operator-panel controller electronics which together with the machine controller electronics enables the machine to also selectively operate in a stand-alone-based mode.

6. The system of claim 5, wherein the operator-panel controller electronics includes a rasterizing and print formatting application-specific-integrated-circuit (ASIC) and includes a memory operatively connected to the ASIC.

7. The system of claim 5, wherein the first operator panel includes a first set of at least one push button operatively connected to the machine controller electronics to at least in part selectively activate the machine controller electronics to enable the machine to function as at least one of the at least two different devices when the first operator panel is attached to the machine, and wherein the second operator panel includes a second set of at least one push button operatively connected to the machine controller electronics to at least in part selectively activate the machine controller electronics to enable the machine to function as at least a different one of the at least two different devices when the second operator panel is attached to the machine instead of the first operator panel.

8. The system of claim 5, wherein the first operator panel includes a first display screen, wherein the second operator panel includes a second display screen, and wherein the machine controller electronics is adapted to display at least one message on the second display screen but not on the first display screen.

9. The system of claim 5, wherein the first operator panel lacks a display screen and wherein the second operator panel includes a display screen.

10. The system of claim 5, wherein the first operator panel includes a first identification code which is recognizable by the machine controller electronics, wherein the second operator panel includes a second identification code which is recognizable by the machine controller electronics and which is different than the first identification code.

11. The system of claim 1, wherein the first operator panel includes a first set of at least one push button operatively connected to the machine controller electronics to at least in part selectively activate the machine controller electronics to enable the machine to function as at least one of the at least two different devices when the first operator panel is attached to the machine, and wherein the second operator panel includes a second set of at least one push button operatively connected to the machine controller electronics to at least in part selectively activate the machine controller electronics to enable the machine to function as at least a different one of the at least two different devices when the second operator panel is attached to the machine instead of the first operator panel.

12. The system of claim 1, wherein the first operator panel includes a first display screen, wherein the second operator panel includes a second display screen, and wherein the machine controller electronics is adapted to display at least one message on the second display screen but not on the first display screen.

13. The system of claim 1, wherein the first operator panel lacks a display screen and wherein the second operator panel includes a display screen.

14. The system of claim 1, wherein the first operator panel includes a first identification code which is recognizable by the machine controller electronics, wherein the second operator panel includes a second identification code which is recognizable by the machine controller electronics and which is different than the first identification code.

15. An all-in-one printing system comprising:
a) a machine which is adapted to function as at least one device, wherein the at least one device is chosen from the group consisting of a printer, a copier, a scanner, a facsimile device, and a photo card reader, and wherein the machine includes machine controller electronics which alone, when activated, enables the machine to operate in a computer-host-based mode;
b) a first operator panel which is removably attachable to the machine and which when attached to the machine interfaces with the machine controller electronics to activate the machine controller electronics to enable the machine to operate in the computer-host-based mode, wherein the machine cannot operate in a stand-alone-based mode when the first operator panel is attached to the machine; and
c) a second operator panel which is removably attachable to the machine instead of the first operator panel, which has operator-panel controller electronics for the machine to operate in the stand-alone-based mode, and which when attached to the machine interfaces with the machine controller electronics to operate the machine in the stand-alone-based mode and to activate the machine controller electronics to enable the machine to also function in the computer-host-based mode.

16. The system of claim 15, wherein the operator-panel controller electronics includes a rasterizing and print formatting application-specific-integrated-circuit (ASIC) and includes a memory operatively connected to the ASIC.

17. The system of claim 15, wherein the first operator panel includes a first identification code which is recognizable by the machine controller electronics, wherein the second operator panel includes a second identification code which is recognizable by the machine controller electronics and which is different than the first identification code.

18. The system of claim 17, wherein the operator-panel controller electronics includes a rasterizing and print formatting application-specific-integrated-circuit (ASIC) and includes a memory operatively connected to the ASIC.

19. An all-in-one printing system comprising: a machine which is adapted to function as at least two different devices,
wherein the at least two different devices are chosen from the group consisting of a printer, a copier, a scanner, a facsimile device, and a photo card reader,
wherein the machine includes machine controller electronics which alone, when activated, enables the machine to function as all of the at least two different devices,
wherein the machine is adapted to receive a first operator panel and to receive a second operator panel instead of the first operator panel,
wherein the first operator panel is removably attachable to the machine and when attached to the machine interfaces with the machine controller electronics to selectively activate the machine controller electronics to enable the machine to function as at least one of the at least two different devices, and wherein the second operator panel is removably attachable to the machine instead of the first operator panel and when attached to the machine interfaces with the machine controller electronics to selectively activate the machine controller electronics to enable the machine to function as at least a different one of the at least two different devices.

20. An all-in-one printing system comprising a machine which is adapted to function as at least one device,
wherein the at least one device is chosen from the group consisting of a printer, a copier, a scanner, a facsimile device, and a photo card reader,
wherein the machine includes machine controller electronics which alone, when activated, enables the machine to operate in a computer-host-based mode,
wherein the machine is adapted to receive a first operator panel and to receive a second operator panel instead of the first operator panel,
wherein the first operator panel is removably attachable to the machine and when attached to the machine interfaces with the machine controller electronics to activate the machine controller electronics to enable the machine to operate in the computer-host-based mode,
wherein the machine cannot operate in a stand-alone-based mode when the first operator panel is attached to the machine, and
wherein the second operator panel is removably attachable to the machine instead of the first operator panel, has operator-panel controller electronics for the machine to operate in the stand-alone-based mode, and when attached to the machine interfaces with the machine controller electronics to operate the machine in the stand-alone-based mode and to activate the machine controller electronics to enable the machine to also function in the computer-host-based mode.
